(19) United States
(12) Patent Application Publication
(10) Pub. No.: US 2009/0051063 A1
(43) Pub. Date: Feb. 26, 2009

(54) METHOD OF EXTRUSION OF PARTICULATE PASTES OR SUSPENSIONS

(75) Inventors: Henrik Stang, Naerum (DK); Helge Fredslund-Hansen, Rodovre (DK); Tony Puclin, New South Wales (AU)

Correspondence Address: NORRIS, MCLAUGHLIN & MARCUS, 875 THIRD AVE, 18TH FLOOR, NEW YORK, NY, 10022, US

(73) Assignee: 3H UNVENTORS APS, Naerum (DK)

(21) Appl. No.: 11/576,034

(22) PCT Filed: Sep. 29, 2005
(86) PCT No.: PCT/AU2005/001516

§ 371 Date: Oct. 8, 2008

(30) Foreign Application Priority Data
Sep. 29, 2004 (AU) 2004905671

(51) Int. Cl. B29C 47/92; B28B 3/20

(52) U.S. Cl. 264/40.1; 264/176.1

(57) ABSTRACT

The extrusion of a green body from a paste or suspension of particulate solids in a liquid is conducted by a process which includes the steps of introducing flowable paste or suspension into an inlet end of a moulding passage which is defined by walls having at least one partially liquid-permeable wall section; applying pressure to the paste or suspension, thereby to remove from the passage at least a major portion of the liquid of the paste or suspension, by establishing a pressure differential across the liquid permeable section, so as to form in the passage a non-flowable body of consolidated particulate solids of the paste or suspension, and to extrude the non-flowable body progressively from an outlet end of the passage. The magnitude of the pressure, the rate of removal of liquid and the rate of extrusion are controlled to maintain the non-flowable body at a length which extends back from the outlet end of the passage and across and beyond the liquid-permeable wall section to provide a portion of the body upstream of the liquid-permeable wall section. Liquid is removed from the passage by constant pressure filtration in which liquid being forced from the suspension is filtered through the portion of the non-flowable body maintained upstream of the liquid permeable section.

### FIELD OF THE INVENTION

This invention relates to the dewatering extrusion of a particulate paste or suspension for the production of self-supporting green body extrudate.

### BACKGROUND TO THE INVENTION

Two basic, conventional extruder types exist for the extrusion of particulate material in the form of a paste or suspension. These are ram extruders (batch type extruders) and screw conveying extruders (continuous extruders). In each case the down-stream end of the extruder consists of a die with a die entry upstream from a die land. The die entry shapes the extrudate to the desired cross-sectional shape and further provides a cross-sectional reduction to allow the shaping process to take place under a suitable pressure. In the following the extrudate of the particulate material is assumed to poses viscous as well as plastically deforming characteristics. Such a material is usually referred to as a visco-plastic material. The physical material characteristics of visco-plastic materials are referred to as rheological properties.

The ram extruder is characterized by the fact that it applies pressure to a predetermined amount of material in a feed chamber by means of a piston (ram). The feed chamber leads to the die, which shapes the material as it passes the die as extrudate. The extrusion pressure is determined by the resistance exerted by the die on the material to form extrudate. That is, the extrusion pressure is determined by the rheological properties of the material to form extrudate in combination with the extrusion speed, which in turn is controlled by the movement of the piston.

In a screw conveying extruder, the piston of a ram extruder is replaced by a screw in a housing. The housing is connected to the feed chamber in such a way that the material to form extrudate continuously can be brought under pressure and fed to the die by the screw. This process only works if the resistance to material flow backwards through the screw is greater than the resistance to material flow through the die. If this condition is fulfilled, the situation is the same as in the ram extruder in the sense that the extrusion pressure is determined by the resistance exerted by the die on the material being extrudated. That is, the extrusion pressure is determined by the rheological properties of the material to be extruded and of resultant extrudate in combination with the extrusion speed, which in turn is controlled by the rotational speed of the screw.

It follows from the above that the rheological parameters of the material being extruded and the extrudate formed from a paste or suspension of particulate material play a major role in the extrusion process using conventional extruders. The rheological parameters of a particle suspension can be described by talking either multi-phase or single-phase models as a starting point. In multi-phase models all components of the particle suspension are modelled explicitly, in terms of, for example, the shape of the particles, their size, size distribution, surface characteristics and volume concentration, as well as the rheological properties of the liquid. The particle suspension is more easily understood, however, and adequately described in the present context, if a so-called single-phase model is used to describe the multi-phase particle suspension. In a single-phase model one constitutive relationship, specifically a relationship that describes the connection between deformation of the material and the associated stresses, is used to describe the rheological behavior of the particle suspension. The rheological parameters of this theoretical single phase material are thought of as parameters implicitly reflecting the characteristics of the particle suspension, the particle size distribution, the size and shape of the particles, the surface characteristics of the particles, the volume concentration of the particles and the rheological properties of the liquid in which the particles are suspended.

A number of single-phase constitutive relationships have been suggested for various types of particle suspensions, all characterized by the fact that they are non-Newtonian, visco-plastic and some furthermore non-linear. That is, it is assumed that a certain yield stress has to be overcome in order to deform the solid and that the solid, once it is deforming, behaves in a viscous manner. These relationships include those of Bingham, Herschel-Bulkley and Casson just to mention a few, with the simplest of these being the Bingham-plastic relationship:

τ=τ₀+μγ, (1)

where τ is shear stress, τ₀ is yield stress, μ is viscosity and γ is strain rate.

In a particulate paste or suspension, as suitably described with the Bingham-plastic relationship, both the yield stress and the viscosity are functions of the phases of the suspension, namely the liquid (often water) and the particles. The viscosity of the liquid influences the viscosity of the suspension, and the volume concentration, packing, surface characteristics, shape and particle size distribution of the particles influence the yield stress as well as the viscosity.

The rheological properties of the suspension are subjected to conflicting demands in an extrusion process. Dimensional stability of the extrudate requires primarily a high yield stress and high viscosity (the latter requirement being particularly important if post processing is slow). In order to prevent large scale movement of the liquid phase relative to the solid particles, that is, phase migration or separation, the viscosity of the liquid should be high (thus giving rise to high viscosity of the suspension). However, from the point of view of the flow in the extruder, the yield stress should be limited in order to prevent formation of static zones in the flow pattern of the material to form extrudate and to limit the extrusion pressure, while the viscosity should be limited to lubricate the process, and also to limit extrusion pressure.

The present invention is particularly concerned with extrusion of cementitious, particulate materials. Extrusion of cementitious materials has proven particularly difficult due to the high inter-particle friction combined with the disastrous effect of static zones in the flow pattern due to setting and hydration, and to the ease of phase migration or separation. The relatively high self-weight of the cementitious extrudate puts high demands on the yield stress in order to maintain shape stability, which makes it even more difficult to avoid static zones in the flow pattern.

In order to deal with these conflicting demands on the rheological properties of cementitious particulate materials, especially the conflicting demands put on the yield stress, various methods have been suggested to dewater the particle suspension during extrusion and in this way allow for low yield stress during flow and shaping of material and a higher yield stress in the processed extrudate. However the practical extrusion of thin-walled cementitious large-scale elements has not been possible until the discovery of the “dewatering extrusion principle” of U.S. Pat. No. 6,398,998 to Krenchel et al, which enabled the contradictory requirements on the yield stress to be accommodated.

British patent GB1080217 to Rouvin et al discloses a process and apparatus for the production of hollow concrete products by extrusion of a fluid concrete mix allowing dewatering. In this, the mix is compressed in an extruder of constant cross-sectional shape by means of a reciprocating piston. Liquid is removed in a terminal part of the extruder, through perforations in the extruder walls, by applying a vacuum outside the walls while the mix being extruded is moving slowly under applied pressure through the extruder.

The total pressure differential across the perforated walls of the extruder of GB 1080217 is not able to be more than of the order of a few bar. Obviously, the contribution to that pressure differential produced by the applied vacuum is not more than about one bar. In addition to that contribution, there is a varying, intermittent force exerted by the reciprocating piston. However, the force executed by the piston is not able to exceed a certain, low level above which it will simply force substantially unconsolidated mix out of the extruder. There is no sufficient counter-force able to prevent such discharge of substantially unconsolidated mix. Moreover, even when operated with a low pressure differential at which this discharge is avoided, the ability of the extruder of GB 1080217 to remove liquid from spaces between particles of the mix is limited. Liquid can be removed to a level at which the extrudate has sufficient structural strength to keep its shape against the force of gravity. However the level of liquid remaining between particles of the extrudate usually is such that, unless extreme care is taken, the relatively fresh, substantially uncured extrudate can not be handled without deforming, collapsing or falling apart.

U.S. Pat. No. 3,905,732, also to Rouvin et al discloses apparatus which, while quite complex in itself, again operates to allow dewatering. U.S. Pat. No. 3,905,732 indicates a further problem with apparatus operating in the manner proposed in GB 1080217. However, the complex apparatus disclosed in U.S. Pat. No. 3,905,732 as a solution to that further problem still necessitates a total pressure differential across the perforated walls of not more than of the order of a few bar. Thus, the problems detailed in relation to GB 1080217 again apply.

U.S. Pat. No. 6,398,998 to Krenchel et al discloses a method in which, as in GB 1080217 and U.S. Pat. No. 3,905,732, bodies of consolidated particulate material are able to be produced by extrusion of a particulate paste or suspension. However, in the case of Krenchel et al., the extrusion process is significantly different from that of GB 1080217 and U.S. Pat. No. 3,905,732, and utilises what is herein referred to as “the dewatering extrusion principle”. In this principle, a pressure differential having a much higher magnitude, such as of 50 to 400 bar, is able to be applied. As a consequence, the extrudate comprises a green body which, in addition to being self-supporting, can be handled or manipulated mechanically immediately on forming, with little risk of deforming, collapsing or falling apart.

As indicated, a relatively low pressure differential is necessary in the proposals of Rouvin et al in GB 1080217 and U.S. Pat. No. 3,905,732. As a consequence, while dewatering is achieved, it is unable to proceed to a stage in which the liquid ceases to be a continuous phase separating at least a significant proportion of the particulate material. It is for this reason that the structural strength of extrudate produced by those proposals does not attain a level substantially obviating the risk of damage to the extrudate if handled on being produced. In contrast, the proposal of Krenchel et al disclosed in U.S. Pat. No. 6,398,998 achieves production of extrudate by the dewatering extrusion principle referred to. Production by that principle denotes dewatering to a stage in which adjacent particles substantially throughout the extrudate are in intimate contact and to a significant degree the liquid has ceased to be a continuous phase. The particulate material in this state and resultant extrudate are said to be consolidated. Due to the liquid ceasing to be a continuous phase, capillary forces develop in the menisci holding the particle skeleton together and give rise to substantial extrudate strength and stiffness. The strength and stiffness of the extrudate produced by this principle is typically referred to as green strength and stiffness. Thus with dewatering extrusion the produced extrudate has substantially different properties compared to the fresh, un-processed, visco-plastic particulate paste or suspension. Further, with this type of extruder the yield stress of the suspension can be maintained as low as desired.

The proposal of U.S. Pat. No. 6,398,998 teaches the need to achieve and maintain, in an exit section of the extruder, a non-flowable “plug” or body of consolidated particulate material and application of the dewatering principle to satisfy this need. When starting up, the outlet end of the extruder initially may be blocked by temporarily fitting an insert into that end to generate a reaction force against the force applied for extrusion. When the particulate material to be extruded has been dewatered adjacent to the insert to a stage producing a non-flowable plug of consolidated particulate material of a length providing sufficient frictional resistance, the insert can be removed to enable extrusion to commence. The plug of consolidated material requires a considerable extrusion pressure to act upon it to overcome friction between it and the extruder walls. The plug thus serves a function similar to that of the temporarily fitted insert in that it generates a reaction force against the pressure applied for extrusion. As a consequence, further consolidated material is progressively produced, by dewatering upstream from the outlet of the extruder, at the same time the consolidated material progressively leaves the extruder as consolidated extrudate.

The magnitude of the extrusion pressure in the proposal of Krenchel et al in U.S. Pat. No. 6,398,998 necessarily is very considerably higher than the extrusion pressure in the proposals of GB 1080217 and U.S. Pat. No. 3,905,732, in order to overcome friction between the consolidated material and the extruder walls. After removal of the insert, the level of friction increases as the length of the non-flowable plug of consolidated material increases upstream from the outlet of the extruder. As disclosed in U.S. Pat. No. 6,398,998, the level of friction to be overcome to enable extrusion may be such that it is necessary to reduce its effect. In fact, in a typical situation the friction between the plug of the consolidated material forming extrudate and the extruder walls increases proportionally to the extrusion pressure since the friction to a large extent is generated as a consequence of the transverse (that is, perpendicular to the extrusion direction) pressure of the plug, of consolidated material forming extrudate, against the extruder wall. Thus increasing the extrusion pressure in itself does not help overcoming the friction. A number of methods are disclosed for this purpose, such as causing the plug of consolidated material forming extrudate to advance step-wise in the downstream direction. This is achieved as one wall of the extruder is moved in that same direction, relative to another wall of the extruder, in the course of relative longitudinal reciprocating movement between those walls. In this case, while the friction is not reduced as the extrusion pressure is maintained at a constant high level, substantially the full effect of the pressure is able to act to overcome the effect of friction between the plug of consolidated material and the other wall.

Reduction of the level of friction results in a reduction in the level of the applied extrusion pressure. However that level still remains relatively high, or it is not reduced at all during extrusion, as indicated above, and results in a relatively high level of both dewatering and consolidation of particulate material. Thus, the extrudate has good structural strength and is able to be handled or manipulated mechanically immediately on forming, with little risk of deforming, collapsing or falling apart.

Due to the high yield stress of the plug of consolidated material in the dewatering extruder, the extrudate no longer flows through the die, but is transported by means of a reciprocating movement of the inner or outer parts of the die or other means of reducing or controlling the friction between extrudate an extruder walls. This gives rise to a fundamental difference between on one hand the ram or screw type of extruder and on the other hand an extruder according to the dewatering principle. In an extruder according to the dewatering principle there is one pressure drop experienced through the die which is flow related and another experienced through the dewatering and frictional sections, the first usually being kept as low as possible, while the second is limited only by practical considerations such as extruder dimensions and pressurizing capacity. Thus in an extruder according to the dewatering principle the extrusion pressure can be chosen independently of the resistance (pressure drop) experienced by the extrudate passing through the die, that is, independently of the rheological properties of the extrudate. In contrast, in traditional ram or screw extruders, the extrusion pressure is determined solely by the flow of the extrudate through the die and thus intimately linked to the rheological properties of the extrudate.

### SUMMARY AND DESCRIPTION OF THE INVENTION

The present invention is directed to providing for the improved production of self-supporting green body extrudate from a particulate paste or suspension, using the dewatering extrusion principle.

An extruder designed for working according to the dewatering principle necessarily contains a so-called dewatering section. This section is located down-stream from an extrusion chamber and up-stream from a frictional section in which the friction between the consolidated extrudate and the extruder walls counteract the extrusion pressure as described above. The dewatering section of the extruder is a section where the extruder wall or walls are perforated with holes or slits allowing the liquid to escape. The extrudate is given its substantially final cross-section in the dewatering section.

In the present invention, the dewatering process, which takes place in the dewatering section, is similar to the unit operation known as filtration in solid-liquid separation techniques. In filtration, suspended solid particles in a fluid are physically or mechanically removed from the fluid by using a porous medium that retains the particles as a separate solid phase or cake and that passes the fluid as clear filtrate. Commercial filtrations cover a very large range of applications. The fluid can be a gas or a liquid. The suspended solid particles can be very fine (in the micrometer range) or much larger, very rigid or plastic particles, spherical or irregular in shape, aggregates of particles or individual particles. The valuable product may be the clear filtrate from the filtration or the solid cake. In some cases, complete removal of the solid particles is required, in other cases only partial removal. In the case of dewatering extrusion of cementitious materials the filtration is by nature a filtration of material including quite fine particles (sub-micron, micron and sub-millimeter size) in a watery suspension, the valuable product being the filter cake.

Because of the diversity of filtration problems, a multitude of types of filters have been developed. Usually filters have a certain service life, before cleaning or replacement is necessary, which depends on the flow rate of the filtrate and the volume concentration of solids. The need to clean or replace the filter derives from the fact that the flow rate of the filtrate decreases as the filter cake increases in thickness (in the case of constant pressure) or the pressure drop over the filter and the filter cake increases as the filter cake increases in thickness (in the case of constant filtrate flow rate), and the efficiency of the process, in terms of the flow velocity of the filtrate, decreases as the filter cake builds up. The pressure drop P over the filter cake can be assessed experimentally or theoretically using, for example, the Blake-Kozeny equation for laminar flow of a Newtonian fluid (filtrate) in a packed bed:

$$P = \frac{150 {μ}_{f} vL}{{D}^{2}} \frac{{( 1 - ɛ )}^{2}}{{ɛ}^{3}} , \qquad ( 2 )$$

where μ_{f} is the viscosity of the filtrate, v is the superficial linear velocity of the filtrate, L is the thickness of the filter cake, D is the effective diameter of the (spherical) particles making up the bed (or filter cake), while ε is the void volume fraction of the bed (or filter cake).

The filtration process itself can be characterized on the basis of geometrical arrangement of the filter and the condition of the particle suspension. A very common configuration is characterized as cross-flow filtration where the particle suspension flows along the filter and the particles are gradually deposited along the filter forming the filter cake. A fundamentally different process is known as constant pressure filtration where a container of pressured particle suspension is closed on one side by a filter. A constant pressure is maintained in the container as the filtrate drains out leaving a filter cake on the filter side of the container. In the case of dewatering extrusion, the filter cake is to form the processed extrudate.

With use of the dewatering principle, dewatering of the particulate paste or suspension can occur at the same time over the whole or parts of the dewatering section of the extruder, similar to cross-flow filtration of other filtration processes.

In the respective proposals of Rouvin et al. in GB 1080217 and U.S. Pat. No. 3,905,721, dewatering effectively is by a single pass, low pressure cross-flow filtration in which the paste or suspension passes in flow parallel to walls of the extruder in which dewatering perforations function as a filter media surface. The proposal of Krenchel et al in U.S. Pat. No. 6,398,998, in establishing and maintaining a plug of consolidated particulate material downstream from the dewatering section, utilises what is more akin to high pressure cross-flow filtration where the particulate material is gradually dewatered and consolidated as it passes the dewatering section and enters the frictional section. The discharge of extrudate from the frictional section results in ongoing removal of the consolidated extrudate from the dewatering section, while simultaneously the material is renewed to provide further filtration and dewatering.

When the dewatering extrusion principle is used together with cross flow filtration there is a risk that un-dewatered extrudate downstream can become ‘shielded’ by dewatered extrudate further upstream, locally lowering the pressure available for dewatering. When that happens, the extrudate will not be fully homogeneous and the liquid content (and thus the green strength and stiffness) will vary from place to place in the extrudate.

We have found that the problems encountered when performing dewatering extrusion based on cross filtration can be effectively overcome if the principle of cross-flow filtration is abandoned in favour of a constant pressure filtration combined with the dewatering extrusion principle.

Constant pressure filtration is achieved when consolidation and dewatering are allowed to progress upstream from the dewatering section of the extruder, effectively including the dewatering section in the frictional section. As determined by the Blake-Kozeny equation, for a given extrusion pressure in the particulate paste or suspension, the flow rate of the liquid through the consolidated extrudate is found to be controlled by the constituents of the particulate material, the viscosity of the liquid as well as the length of the consolidated extrudate measured upstream from the start of the dewatering section to the beginning of consolidation. Further, the higher the extrusion pressure the higher the flow rate of the liquid through the filter cake.

The invention thus involves a specific way of controlling the extrusion process in terms of extrusion pressure and extrusion rate which is related both to the physical characteristics of the particulate material being extruded (in terms, for example, of the shape of the particles, their size, size distribution, surface characteristics and volume concentration), and to the rheological characteristics of the liquid in which the particles are suspended. This way of controlling the dewatering extrusion process can be regarded as stable extrusion because it is found that small variations in the controlling parameters only give rise to small changes in the extrusion conditions and no or very little change in the quality of the processed extrudate. The particulate suspension is able to be characterized in a simple well known consolidation test of which the result is able to be interpreted in terms of a single material parameter called the consolidation constant C. Extrusion according to the stable extrusion method requires a dewatering section in the extruder in which the pressure drop across the holes or slits providing perforations is substantially smaller than the pressure drop over the consolidated extrudate, even for small consolidation thickness. Further, the stable extrusion methods allows for simplified extruder design in that the dewatering section can be substantially shortened.

As detailed above, U.S. Pat. No. 6,398,998 describes the de-watering extrusion principle, and this is illustrated by a generic extruder with a circular cross section for pipe extrusion. The extruder is described as consisting of four sections of: an inlet section A for the supply of flow-able suspension to be compacted and leading into a flow section B in which the suspension is able to flow forward into a drainage and consolidation section C. In section C the walls of the outer and possibly also the inner mold are perforated, thus forming a filter. Finally, the extruder has a solid friction section D. The dewatering and consolidation is described as taking place gradually over the dewatering section, with high hydrostatic pressure reigning in the flow section B and at least the adjacent part of the drainage and consolidation section C. Further it is mentioned that with squeezing-out of the liquid at the same time over the whole surface of the mould, there is a risk that un-dewatered extrudate downstream can become ‘shielded’ by dewatered extrudate further upstream, locally lowering the pressure available for dewatering with the result that the end product will not become fully homogeneous. It is suggested that this disadvantage may be avoided by the use of a mold in which the perforations are distributed and adapted to in such a manner so that the liquid will be expressed first from the parts of the mold situated most distant from the slurry inlet, then from parts of the mold less distant from said inlet, then from parts still closer to the inlet and so forth, until the complete molding space is occupied by closely packed and consolidated particulate material forming a compact body with very low porosity.

U.S. Pat. No. 6,398,998 indicates that the steps of introducing the suspension into the complete molding space and removing at least a major portion of the of the liquid by establishing a pressure differential across the liquid permeable wall of the drainage and consolidation section C, commence as a high-pressure slurry pumping process and terminate as a powder-pressing process. The pressure applied establishes a pressure differential across the liquid permeable wall with a magnitude of 20-400 bar, such as 50-400 bar. The apparatus commences in the form of high-pressure slurry pumping in one end of the molding space and terminates as a powder-pressing process steadily progressing from the other end of the molding space.

The present invention relates to the improved production of self-supporting green body extrudate, from a paste or suspension of particulate solids and a liquid, based on the dewatering extrusion principle.

According to the present invention, there is provided a process for the extrusion of a green body from a paste or suspension of particulate solids in a liquid wherein the process includes the steps of:
(1) introducing flowable paste or suspension into an inlet end of a moulding passage which is defined by walls having at least one partially liquid-permeable wall section;
(2) applying pressure to the paste or suspension, thereby:
   (i) to remove from the passage at least a major portion of the liquid of the paste or suspension, by establishing a pressure differential across the liquid permeable section, so as to form in the passage a non-flowable to body of the particulate solids of the paste or suspension, and
   (ii) to extrude the non-flowable body progressively from an outlet end of the passage;
      wherein the magnitude of the pressure, the rate of removal of liquid and the rate of extrusion are controlled to maintain the non-flowable body at a length which extends back from the outlet end of the passage and across and beyond the liquid-permeable wall section to provide a portion of the body upstream of the liquid-permeable section whereby liquid is removed from the passage by constant pressure filtration in which liquid being forced from the suspension is filtered through the portion of the non-flowable body maintained upstream of the liquid permeable section.

The invention establishes a method which enables a stable and reliable dewatering extrusion to be carried out to provide a fully dewatered and homogeneous product. The method enables a solution to the problem that if dewatering of the particulate suspension occurs at the same time over the whole or parts of the dewatering section of the mould, that is, by cross-flow filtration, there is a risk that un-dewatered extrudate downstream can become ‘shielded’ by dewatered extrudate further upstream, locally lowering the pressure available for dewatering with the result that the end product does not become fully homogeneous. The invention is based on the discovery that this can be achieved effectively if the principle of cross-flow filtration is abandoned and if a constant pressure filtration is combined with the dewatering principle instead. Constant pressure filtration is achieved when dewatering and consolidation is allowed to progress up-stream from the de-watering section of the dewatering extruder. For a given extrusion pressure in the particle suspension, the flow rate of the liquid through the consolidated extrudate will be controlled by the solid constituents, the viscosity and amount of the liquid as well as the length of consolidated extrudate measured upstream from start of the dewatering section to the beginning of consolidation. The flow rate of liquid is proportional to the growth rate of consolidated extrudate, which will be denoted as the consolidation rate. Since the consolidated extrudate is constantly moved forward by the extrusion process the length of consolidated extrudate is continuously reduced, either stepwise or with a substantially constant rate depending on the way friction is controlled as explained above. Thus on one hand the length of consolidated extrudate is continuously increased according to the consolidation rate and on the other the length of consolidated extrudate is reduced according to the average extrusion rate. If average extrusion rate is lower than the consolidation rate the length of consolidated extrudate will effectively grow up-stream. If average extrusion rate is higher than the consolidation rate then the length of consolidated extrudate will effectively decrease. However, since the consolidation rate decreases when the length of consolidated extrudate grows up-stream and since the consolidation rate increases when the length of consolidated extrudate decreases downstream, then an average equilibrium will be established unless extrusion speed is so high that the length of consolidated extrudate upstream from the upstream end of the dewatering section is reduced to zero and the process gradually becomes a cross flow filtration process or if the extrusion speed is so low that the consolidated extrudate grows into the extrusion chamber. In practice, since dewatering will always have to pass through a lateral thickness of consolidated extrudate equal to the full or half the wall thickness of the extrudate (depending of whether perforation is provided in one or both extruder walls) the maximum extrusion rate corresponds to a consolidation rate determined by the extrudate wall thickness and the configuration of the perforations in the extruder wall(s), as explained later. The equilibrium state is called stable extrusion since small changes in extrusion pressure, the constituents of the particle suspension and/or the extrusion rate just introduces a new equilibrium state characterized by a small change in the average distance from the dewatering section to the start of the consolidated extrudate and since this gives rise to no or very small changes in the quality of the processed extrudate.

Where a dewatering extrusion method is used which continuously reduces and controls the effect of the friction between the consolidated extrudate and the extruder walls, the average extrusion rate most preferably will simply be the substantially constant extrusion rate applied. In a case where friction is not reduced and a reciprocating movement of the extruder walls is applied to control the extrusion rate as explained above, the average extrusion rate will be determined by the parameters of the cyclic, reciprocating movement including the period and the amplitude.

In practice, the stable dewatering extrusion enabled by the present invention can be facilitated by the further step in the extrusion process of, for a given extrusion pressure, maintaining an extrusion rate (preferably an average rate) which is below the consolidation rate determined by the relevant lateral wall thickness of consolidated extrudate and the configuration of perforations in the extruder wall(s), but above the consolidation rate corresponding to a consolidation length which corresponds to growth of the consolidated extrudate into the moulding passage. To assist in maintaining an extrusion rate between these limits, the extrusion pressure can be maintained substantially constant whereby operation is in substantial compliance with a relationship reflecting the consolidation rate as a function of the length of consolidated extrudate at the relevant substantially constant pressure. As an alternative, or in addition, to such compliance, the extrusion process may be monitored in real time, such as with reference to the position of the consolidation front to ensure that the extrusion rate is maintained between those limits at all times.

The relationship reflecting the consolidation rate as function of length of consolidated extrudate will preferably be determined experimentally or theoretically with an experimental verification. In this, and also in the alternative in which the extrusion process is monitored in real time, the Blake-Kozeny relationship of equation (2) above can serve as an explanation for the fundamental parametric dependencies. Restating that relationship:

$$P = \frac{150 {μ}_{f} vL}{{D}^{2}} \frac{{( 1 - ɛ )}^{2}}{{ɛ}^{3}} ,$$

μ_{f} and v as the viscosity and superficial linear velocity of the filtrate are the viscosity and velocity of the liquid phase of the suspension, L as the thickness of the filter cake is the longitudinal extent of consolidated material upstream of the liquid permeable section—effectively limited to lateral wall thickness as L becomes smaller, D as the effective diameter of the filter cake is the mean diameter of the solids of the suspension, while ε as the void volume fraction of the filter cake is the void volume fraction of that upstream consolidated material.

The lateral wall thickness will correspond to the full wall thickness of the extrudate or half that thickness depending, respectively, on whether dewatering is through one or each of opposite extruder walls.

An extruder operating according to the stable dewatering principle will only need a short dewatering section, since almost all dewatering takes place through the first, upstream part. From a practical point of view a reliable dewatering section typically has a length in the order of 1-5 or 2-10 times the wall thickness of the extrudate, depending on whether perforation is provided in both or in only one of the extruder walls. Further it is required that the perforations in the extruder wall—slits or holes—are large enough for the pressure drop to be small compared to the pressure drop over the consolidated extrudate.

In order that the invention may more readily be understood, description now is directed to the accompanying drawings, in which:

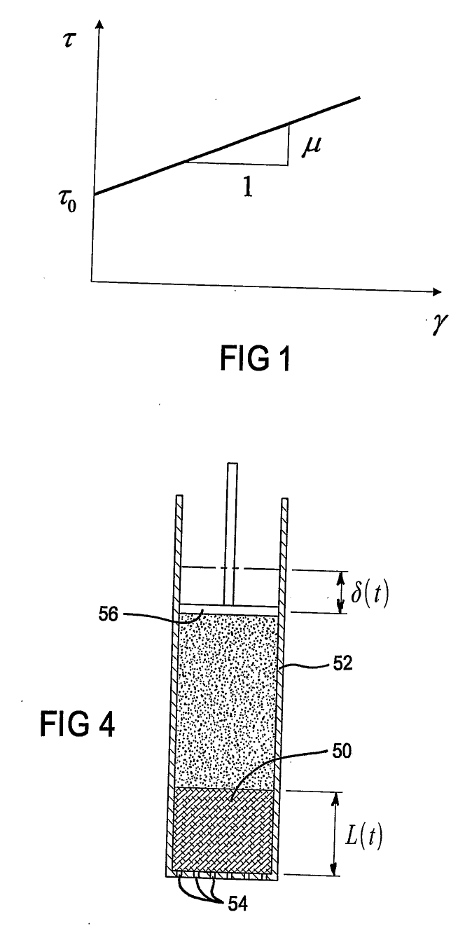

FIG. 1 is a graphical illustration of the Bingham visco-plastic relationship;

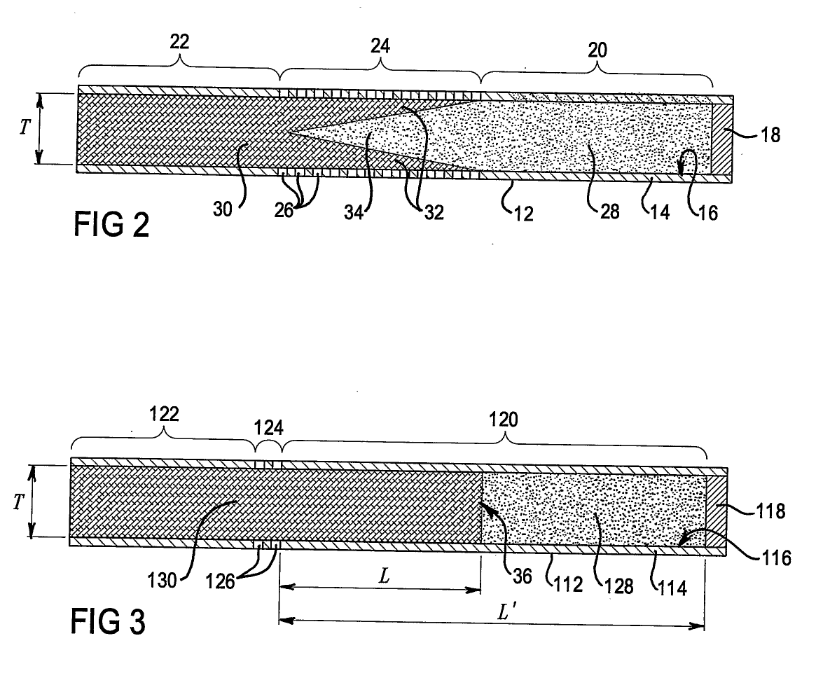

FIG. 2 is a schematic representation of a prior art arrangement for dewatering extrusion;

FIG. 3 is a schematic representation of an arrangement for extrusion dewatering according to the present invention;

FIG. 4 is a schematic representation of an experimental arrangement for determining dewatering characteristics of a paste or suspension of particulate solids;

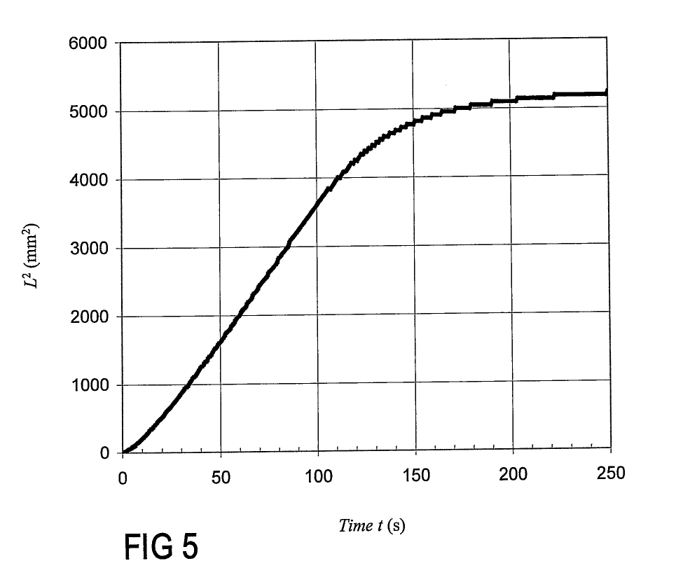

FIG. 5 is a graphical illustration of consolidating length as a function of time;

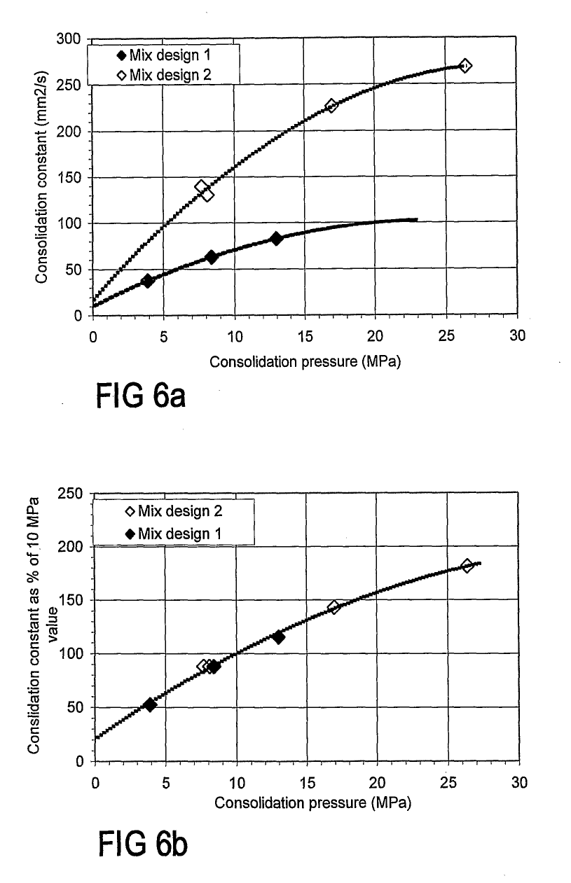

FIG. 6 is a graphical representation of the consolidation constant C as function of consolidation pressure for two typical mixes of cementitious material to be extruded plotted in terms of (a) absolute values and (b) as values relative to the consolidation constant at a consolidation pressure of 10 MPa;

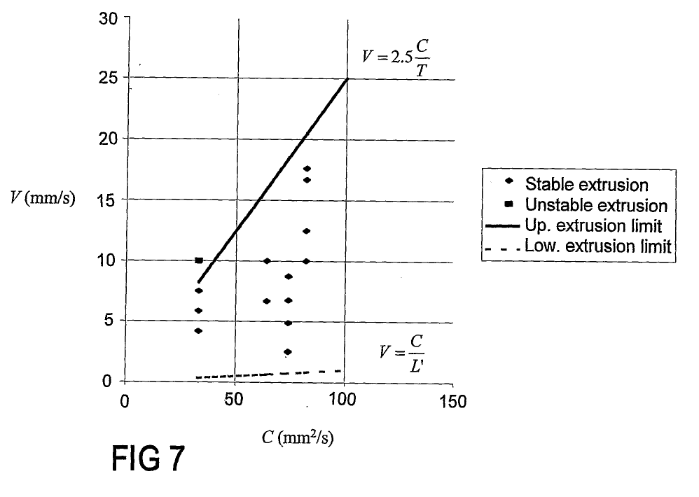

FIG. 7 is plot representation of fitted maximum and calculated minimum extrusion rates together with extrusion rates obtained in practice in a laboratory extruder; and

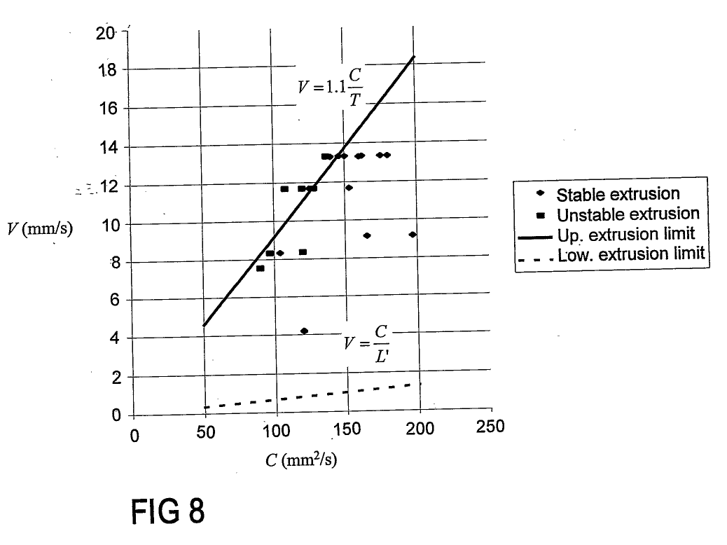

FIG. 8 is graphical representation of fitted maximum and calculated minimum extrusion rates together with extrusion rates obtained in practice in an industrial scale extruder.

FIG. 1 illustrates the Bingham visco-plastic relationship. This linear relationship is appropriate for many suspensions of particulate material. Our findings confirm the appropriateness of the relationship for cementitious suspensions, and cementitious suspensions are the preferred suspensions for use in the present invention. Most preferably, the cementitious suspension suitable for dewatering extrusion to provide a product is a fibre reinforced material, most preferably an engineered cementitious composite (ECC). A suitable cementitious suspension may be one from the following composition range in parts by weight:

| | |
|---|---|
| Cement | 0.3 to 0.8 |
| Pozzolanic material | 0.1 to 0.3 |
| Particulate material | 0.1 to 0.4 |
| Water | 0.1 to 0.5 |

with from 1 to 5 volume % of fibre with respect to the total solids. An ECC material usually includes Portland cement, such as general purpose or high early strength grade, in combination with at least one pozzolan. The particulate material usually is fine sand and/or quartz powder, having a particle size less than 1 mm, such as less than 0.1 mm. The fibre may be organic and/or mineral fibre, with polymeric fibres preferred. Suitable polymeric fibres include polypropylene, polyvinyl acetate, polyvinyl alcohol, polyamide, polyimide, polyacrylonitrile fibres, and blends of such fibres. The solids are mixed with sufficient water plus, if required, a dispersing agent and/or superplasticizer, to produce a flowable suspension mix suitable for extrusion. The suspension may have a water to binder (cement plus pozzolan) ratio of about 0.3 to 0.5, with this being substantially reduced by dewatering extrusion. The water binder ratio may be reduced by dewatering extrusion to about 0.2 or lower, but the ratio generally is reduced to about 0.22 to 0.26.

FIG. 2 schematically illustrates part of ram extruder. The illustration is of walls 12 and 14 defining part of a moulding passage 16 with a ram 18 provided for applying pressure for extrusion. The part shown could be a longitudinal section through the walls 12 and 14 for use in extruding a thin-walled cementitious large scale element, for example a flat panel or a tubular member such as a pipe. In the case of a panel, a respective major surface of the panel may be formed against each of walls 12 and 14, with passage having a width perpendicular to the plane of FIG. 2 which is greater than the spacing between walls 12 and 14. In the case of a pipe, the illustration is a radial section through concentric cylindrical walls 12 and 14. In each case, the ram 18 has a form transversely of passage 16 which corresponds to transverse cross-section of passage 16.

Along the length of passage 16, the walls 12, 14 and passage 16 define an inlet section 20, a friction section 22 and, between sections 20 and 22, a dewatering section 24. Along section 24, a plurality of openings 26 are provided in each of walls 12 and 14. While shown as provided in each of walls 12 and 14, openings 26 need be provided in only one of those walls.

Ram 18 is retracted (to the right in the orientation of FIG. 2) to allow particulate suspension 28 to be supplied to fill passage 16 through port (not shown). The ram 18 then is advanced to the left to achieve a power stroke. The outlet end of passage 16 remote from ram 18 initially is blocked by inserting a fitting (not shown) into that end to generate a reaction force against the force applied by a power stroke of ram 18. This results in dewatering of the suspension, by liquid passing through openings 26, and a consequential build-up of a non-flowable body of consolidated particulate material 30 which extends from the insert and back along section 22 into the dewatering section 24. The friction between the walls 12 and 14 (and any side walls therebetween) and the body of consolidated material 30 generates a reaction force against the force applied by ram 18. The length of section 22 is such that the reaction force generated by that friction enables removal of the fitting at the outlet end of passage 16. Extrusion then is able to occur with each further power stroke of ram 18. The means of reducing and controlling the friction during extrusion are not shown in FIG. 2.

FIG. 2 illustrates operation in accordance with the disclosure of Krenchel et al in U.S. Pat. No. 6,398,998. As shown, the body of consolidated material 30 is able to extend back along substantially the full length of the dewatering section 24. The particulate material of the suspension consolidates in a layer 32 against the walls 12 and 14 in section 24. The layers 32 progressively increase in thickness, along section 24, until consolidated material occupies the full cross-section of passage 16 adjacent to and downstream from the junction between sections 22 and 24. This build-up is shown in an idealised form in FIG. 2, although the arrangement is such that dewatering occurs by cross-flow filtration relative to the movement of suspension along passage 16. That is, liquid passes from a partially dewatered core 34 of suspension 28 in section 24, laterally through the layers 32 to the openings 26 in walls 12 and 14. However maintaining stable operation with this form of filtration is difficult. The build-up of layers 32 can become irregular, while partially dewatered regions of suspension 28 in core 34 can become engulfed in the body of consolidated material 30. This leads to production of extrudate which is not fully homogeneous in its water content and also its degree of consolidation. The green strength and stiffness of the extrudate can very along its length, while a resultant product can have localised weakness making it unsuitable for its intended application.

FIG. 3 is similar to FIG. 2, but shows operation in accordance with the present invention. In large part the arrangement illustrated in FIG. 3 and operation with it will be understood from reference to description of FIG. 2. The corresponding features shown in FIG. 3 therefore have the same reference numeral as used in FIG. 2, plus 100.

In FIG. 3, the length of the dewatering section 124 is relatively short. In the representation it is depicted essentially by openings 126. In terms of hardware depicted, this is the principal difference. Again, the means of reducing and controlling the friction in the frictional (122) and dewatering section (124) during extrusion are not shown in FIG. 3.

On start-up with the arrangement of FIG. 3, a fitting initially provided at the outlet end of passage 116 is retained for a period such that the non-flowable body of consolidated particulate material 130 extends back through and beyond the dewatering section 124. Thus, a portion of the consolidated material is upstream of the dewatering section 124. Also, the transition between the particulate suspension 128 and the body of consolidated material 130 is marked by a consolidation front 36 which extends transversely across passage 116, between walls 112 and 114. As a consequence, cross-flow filtration, and a build-up of layers along walls 112 and 114 which enable this, are precluded. Rather, the portion of the body of material 130 which is upstream of openings 126 and within inlet section 120, enables constant pressure filtration. Under a constant pressure applied by ram 118 during extrusion, the rate of discharge of extrudate from the outlet end of passage 116 is matched within limits with the rate of consolidation of particulate material at the consolidation front 36 to maintain a part of consolidated material 130 upstream of dewatering section 124. Under such constant pressure, that upstream part of material 130 acts as a filter bed through which liquid passes longitudinally to the dewatering section 124, to issue through openings 126, to provide dewatering by constant pressure filtration.

With such operation by constant pressure filtration, a given extrusion pressure established during a power stroke of ram 118 is found to enable dewatering in accordance with the Blake-Kozeny relationship of equation (2). That is, for such given pressure, the flow rate of liquid through the portion of the body of material 130 upstream of openings 126 is controlled by the length of that portion, the viscosity of the liquid and the mean particle size of the solids of the material 130. The viscosity of the liquid and the mean particle size of the solids should be substantially constant in a well prepared suspension for extrusion. Consistent with this, it is found that the length of the portion of the material 130 upstream of openings 126 can be maintained substantially constant. Thus, extrusion is able to be controlled in terms of extrusion pressure and extrusion rate, to enable stable extrusion and, in particular, extrusion which is free of problems encountered with cross-flow filtration. Also, the flow rate of liquid through the material 130 in constant pressure filtration increases with the extrusion pressure, such that extrusion rate is able to be increased with little if any change in the quality of the extrudate.

A further understanding of the stable extrusion principle of the present invention can be gained from the following, related to the section of the extruder based on that principle, as shown in FIG. 3. Left (downstream) is shown the body of consolidated material 130 occupying the dewatering section 124 and the frictional section 122 of the extruder. The wall thickness of the extrudate is T. The dewatering section 124 shown is quite short and consists only of a few sets of openings 126 in the extruder walls 112 and 114. To the right (upstream) is the inlet section 120, which may be connected to a pressurizing chamber (not shown) or, as shown, is pressurised by ram 118. The inlet section 120 is partially filled with particulate suspension 128, and partially with the body of consolidated material 130, which has grown into the inlet section 120 of the extruder. The transition between consolidated material 130 and the particulate suspension 128 is the consolidation front 36 and the distance from the upstream end of the dewatering section 124 to the consolidation front 36 is the consolidation length, L.

Since liquid is passing through the consolidated material 130 during a power stroke of ram 118, with the material 130 acting as a filter, there is a continuous flow of particulate suspension 128 in the downstream direction. Since particles are deposited on the consolidation front 36, the consolidation front grows upstream.

The consolidated extrudate acts as a filter with characteristics as given in equation. (2). Rearranging and rewriting equation (2) provides:

$$Q = KA \frac{P}{L} \qquad ( 3 )$$

also known as Darcy's law, where Q is the total flow rate of the liquid through the consolidated material 130, A is the cross sectional area of the passage 116 of the extruder and K is a constant containing information about viscosity of the liquid, size of the particles and void volume fraction in the consolidated known as the hydraulic conductivity.

Introduction of the fraction w of liquid being drained by dewatering to the volume of consolidated material 130 (including voids) upstream of section 124, provides the following relation between flow rate of liquid in a time step, dt, and the corresponding increase in consolidation length:

Qdt=wAdL (4)

Combining eqs. (3) and (4) and solving the resulting differential equation in the case of constant pressure, gives the following expression for L(t):

L(t)=\sqrt{Ct} (5)

which is the standard solution to one-sided drainage also know from geotechnical engineering. The constant C is referred to herein as the consolidation constant.

The consolidation constant C depends only on the properties of the consolidated material 130, the liquid and the pressure. When applying C in analysis of the consolidation process in the extruder, it is assumed that the openings 126 in the extruder walls 112 and 114 are large enough that the pressure drop over the openings 126 is small compared to the pressure drop over the consolidated material 130. Also, it is assumed that the consolidated material 130 has grown a reasonable distance upstream from the openings 126, that is, that L is larger than the wall thickness of the consolidated extrudate, T.

From equation (5) the following expression for the rate of growth of the consolidation length, or the consolidation rate is able to be derived:

$$\frac{d L}{d t} = \frac{C}{2} \frac{1}{L} = \sqrt{C} \frac{1}{2 \sqrt{t}} \qquad ( 6 )$$

From this it follows that the consolidation rate decreases with time and increasing consolidation length, given a constant extrusion pressure.

During extrusion the consolidated material 130 is transported in the downstream direction. This is done with a certain average speed V. This average speed should be measured over a certain characteristic period. In the case of the extrudate being moved with a reciprocating movement of the inner and outer die, the average extrusion speed is given by:

$$V = \frac{f}{c} \qquad ( 7 )$$

where f is the length of the downstream stroke and c is the time it takes to complete a full reciprocation cycle.

For a given extrusion rate V, a certain average consolidation length can be found so that

$$V = \frac{d L}{d t} \qquad ( 8 )$$

Relationship (8) means that on average the consolidation front 36 grows as fast up-stream as the extruder brings the consolidated material 130 down stream. This situation is stable, since a small increase in extrusion rate gives rise to a small decrease in consolidation length L, while a decrease in extrusion rate gives rise to an increase in consolidation length L.

In theory there is always a consolidation length L that accommodates a certain extrusion rate. However the length L′ of the inlet section of the extruder and the wall thickness T of the extrudate put natural limitations on the extrusion rate.

We have found that in practice when operating an extruder according to the dewatering principle, obtaining a stable situation require that the following conditions are observed:

$$\begin{matrix}Φ < V < Θ \\ where & ( 9 ) \\ Φ ∝ \frac{C}{{L}^{′}} = \frac{2 K}{w} \frac{P}{{L}^{′}} and Θ ∝ \frac{C}{T} = \frac{2 K}{w} \frac{P}{T} & ( 10 )\end{matrix}$$

The derivations carried out above are based on the assumption that the cross sectional area, A, in Darcy's law, equation (3), is constant and related to the wall thickness T. This is not true when the consolidation length L becomes very small. The flow path of the liquid through the consolidated material 130 close to the openings 126 in the extruder walls 112 and 114 is restricted to areas dictated by the cross sectional area of the openings 126 and when the consolidation length L becomes small, the pressure drop related to this part of the flow path becomes significant. Therefore the upper limit for the extrusion rate is influenced by the configuration (dimensions and spacing) of the openings 126 in the extruder wall(s). In practice the upper bound, Θ, as well as the lower bound, Φ, should always be established by full-scale testing, although the linear dependency on C is always maintained.

Equations (9) and (10) correspond to conditions for stable extrusion according to the dewatering extrusion principle based on constant pressure filtration. It is seen that the conditions defines modes of operation in terms of extrusion rate and extrusion pressure which depend on the extruder geometry and the particulate material being extruded. Further the above gives directions for extruder design (desirable pressure—as high as possible, inlet section length—as long as possible and extruder wall perforations—as effective as possible) and particulate suspension material design, (hydraulic conductivity—as high as possible and liquid content—as low as possible).

In practice the cost effectiveness of the extruder requires that the extrusion speed is set as close to the upper limit as possible. Thus it becomes very important to determine the dewatering characteristics of the particulate material, given by the upper limit in equation (9). This can be done e.g. with the aid of an instrumented constant pressure filtration arrangement described in the following.

The dewatering characteristics of the particulate suspension to be extruded using the stable dewatering extrusion principle are preferably determined routinely in order to optimise cost effective extrusion, that is, extruding close to the maximum extrusion rate as defined by equations (9) and (10). Also it is important to ensure that the applied extrusion rate is well above the lower limit. This can be facilitated in practice by placing a suitable amount of particulate suspension 50 to be extruded in a cylindrical container 52 as shown in FIG. 4. The bottom of the container has perforations 54, allowing only the liquid to be drained from the particulate suspension. The perforations 54 should be designed such that the pressure drop over the perforations is small compared to the pressure drop over a small amount of consolidated solids of the suspension. A piston 56 is placed in the top end of the container 52 and loaded with a constant force resulting in a constant pressure in the suspension similar to the extrusion pressure. Once the force is applied, the dewatering process starts at the perforated bottom end of the container. As the liquid is drained out, the piston 56 experiences a displacement, δ, over time. When the suspension is dewatered and the solids are fully consolidated the displacement of the piston stops. During the experiment the displacement, δ, is measured as a function of time.

From equation (5) it is evident that:

L²(t)=Ct (11)

Further it follows from the definition of w, that in the consolidation experiment described with reference to FIG. 4:

δ(t)=wL(t) (12)

Thus,

δ²(t)=Cw²t (13)

The consolidation constant C is able to be determined when the square of the displacement of the piston is plotted against time and the slope is determined. The consolidation constant is then determined from:

$$C = \frac{d ( {δ}^{2} )}{d t} \frac{{L}_{1}^{2}}{{δ}_{1}^{2}} = \frac{d ( {L}^{2} )}{d t} \qquad ( 14 )$$

where L₁ and δ₁ are the final length of the consolidated solids and the final displacement of the piston, respectively. Since the final displacement of the piston is directly related to the amount of liquid expelled, information about δ₁ can accurately be obtained by weighing the specimen before and after the experiment.

In FIG. 5 a typical plot of the square of the consolidated length as a function of time is shown, indicating the expected linear behaviour for a typical cementitious particulate suspension based on ordinary Portland cement. Deviation from the linear behaviour is noted in the beginning (until full contact pressure is obtained) and at the end (when the consolidation front has reached the piston and a viscous deformation of the consolidated extrudate takes place).

Further, the dependency of the consolidation constant C on applied pressure P has been investigated. The theory underlying equation 10 predicts a linear dependency of C on P. This has been demonstrated to hold approximately for different cementitious materials up to pressure of about 15 MPa. From thereon the consolidation constant C increases less, as shown in FIG. 6 (a), probably due to the compression of the capillary channels in the consolidated material. It is worthwhile noting that the degree of linearity of consolidation constant on pressure is independent of mix details as shown in FIG. 6 (b) where the consolidation constant for the two mixes are shown as values relative to the consolidation constant at a consolidation pressure, P, of 10 MPa

When carrying out extrusion according to the stable dewatering extrusion principle, reaching the upper and lower limits for average extrusion rate at a given extrusion pressure will result in:
(a) The consolidation length exceeding the length of the upstream inlet section usually resulting in blockage of the extruder since the extruder geometry upstream from the inlet section typically is characterized by an increase in cross sectional area (extruding too slow).
(b) The extrudate will start to show wet patches of insufficiently dewatered extrudate possibly leading to decreased strength and stiffness of the green material and possibly a loss of friction in the frictional section resulting in an uncontrolled push-out of consolidated extrudate ultimately leading to a pressure drop (extruding too fast).

Both situations are highly undesirable. However due to the fact that cost effectiveness is improved with increasing extrusion rate it is desirable to use an extrusion rate which is high as possible. Thus it is important to explicitly determine the upper limit in equations (9) and (10). For a given extruder type, the configuration of the openings in the dewatering section, extrusion pressure and a given extrudate wall thickness, the maximum extrusion rate according to the present method depends linearly on the consolidation constant, C.

Using a laboratory extruder for extruding 100 mm diameter pipe with T=10 mm at extrusion pressure 10 MPa, cementitious particulate suspensions with different consolidation constant were extruded at various extrusion rates and the stability of the process observed. The results are plotted in FIG. 7 indicating also the experimentally observed linear relationship between C and maximum extrusion rate obtained by fitting a straight line between stable and unstable extrusion rates. Also the calculated, minimum extrusion rate is shown based on an inlet length of 100 mm.

Results similar to the results in FIG. 7 are shown in FIG. 8, referring to results obtained using an industrial scale extruder for extruding pipe with T=12 mm at extrusion pressure 10 MPa. Again, a straight line separates stable and unstable extrusion rates reasonably accurately for the investigated range of C. It is furthermore apparent that the laboratory extruder has a more efficient configuration, i.e. a higher maximum extrusion rate for a given C over T ratio. Finally, in FIG. 8 also the calculated, minimum extrusion rate is shown based on an inlet length of 150 mm.

Finally, it is to be understood that various alterations, modifications and/or additions may be made without departing from the spirit of the present invention as outlined herein.

1. A process for the extrusion of a green body from a paste or suspension of particulate solids in a liquid, wherein the process includes the steps of:
(1) introducing flowable paste or suspension into an inlet end of a moulding passage which is defined by walls having at least one partially, liquid-permeable wall section;
(2) applying pressure to the paste or suspension, thereby;
(i) to remove from the passage at least a major portion of the liquid of the paste or suspension, by establishing a pressure differential across the liquid permeable section, so as to form in the passage a non-flowable body of consolidated particulate solids of the paste or suspension, and
(ii) to extrude the non-flowable body progressively from an outlet end of the passage;
wherein the magnitude of the pressure, the rate of removal of liquid and the rate of extrusion are controlled to maintain the non-flowable body at a length which extends back from the outlet end of the passage and across and beyond the liquid-permeable wall section to provide a portion of the body upstream of the constant pressure filtration in which liquid being forced from the suspension is filtered through the portion of the non-flowable body maintained upstream of the liquid permeable section.

2. The process of claim 1, including the step of, for a given extrusion pressure, maintaining an extrusion rate which is:
(a) below a consolidation rate for the particulate solids determined by the wall thickness of consolidated extrudate and the configuration of perforations in the extruder walls, but
(b) above a consolidation rate corresponding to a consolidation length corresponding to growth of consolidated extrudate in the moulding passage.

3. The process of claim 1, wherein the extrusion pressure is maintained substantially constant whereby operation is in substantial compliance with a relationship reflecting the consolidation rate as a function of the length of consolidated extrudate.

4. The process of claim 3, wherein the relationship is determined experimentally or theoretically with experimental verification.

5. The process of claim 3, wherein the process is monitored in real time.

6. The process of claim 5, wherein the process is monitored in real time with reference to the position of a front of the consolidated particulate material.

7. The process according to claim 1, wherein fundamental parametric dependencies for the process are determined in accordance with the Blake Kozeny relationship:
$$P = \frac{150 {μ}_{f} {L ( 1 - ɛ )}^{2}}{{D}^{2} {ɛ}^{3}} , \qquad ( 2 )$$
wherein μ_{f} is the viscosity of the liquid of the suspension, v is the superficial linear velocity of the liquid of the suspension, L is the effective lateral wall thickness of the extrudate, D is the effective diameter of the particles of the particulate solids in the body of particulate material, and ε is the void volume fraction of the portion of the body of particulate material upstream of the liquid permeable wall section.

8. The process of claim 7, wherein a partially liquid permeable wall section is provided in only one of opposed walls defining the moulding passage, and the effective lateral wall thickness is the full wall thickness of the extrudate.

9. The process of claim 7, wherein a partially liquid-permeable wall section is provided in each of opposed walls defining the moulding passage, and the effective lateral wall thickness is half the full wall thickness of the extrudate.

10. The process of claim 8, wherein the length of the liquid-permeable wall section is from 2 to 10 times the full wall thickness of the extrudiate.

11. The process of claim 9, wherein the length of the liquid permeable wall section is from 1 to 5 times the full wall thickness of the extrudate.

12. The process according to claim 1, wherein the at least one partially liquid-permeable section is defined by perforations in the walls of the moulding passage through which where is a pressure drop which is substantially smaller than a pressure drop over the consolidated extrudate.

13. The process according to claim 1, wherein the following conditions apply:
$$Φ < V < Θ$$
$$where$$
$$Φ ∝ \frac{C}{{L}^{′}} = \frac{2 K P}{{wL}^{′}} and Φ ∝ \frac{C}{T} = \frac{2 K P}{wT}$$
and where V is the extrusion rate, C is the consolidation constant, L′ is the length of the passage upstream from the liquid-permeable wall section, K is the hydraulic conductivity constant, P is the pressure drop over the portion of the non-flowable body upstream of the liquid-permeable section, w is the fraction of liquid being removed by dewatering to the volume of that portfolio of the non-flowable body (including voids), and T is lateral wall thickness.
